(19) United States
(12) Patent Application Publication
(10) Pub. No.: US 2016/0236941 A1
(43) Pub. Date: Aug. 18, 2016

(54) PROCESS FOR DEOXIDIZING SILICON

(71) Applicant: COMMISSARIAT A L'ENERGIE ATOMIQUE ET AUX ENERGIES ALTERNATIVES, Paris (FR)

(72) Inventors: Malek BENMANSOUR, La Motte Servolex (FR); Sarah DARWICHE, Rives (FR); Jean-Paul GARANDET, Saint Cloud (FR); David PELLETIER, La Ravoire (FR)

(73) Assignee: COMMISSARIAT A L'ENERGIE ATOMIQUE ET AUX ENERGIES ALTERNATIVES, Paris (FR)

(21) Appl. No.: 15/027,066

(22) PCT Filed: Sep. 30, 2014
(86) PCT No.: PCT/IB2014/064964

§ 371 Date: Apr. 4, 2016

(30) Foreign Application Priority Data
Oct. 3, 2013 (FR) 13 59611

(51) Int. Cl. C01B 33/037

(52) U.S. Cl. CPC C01B 33/037

(57) ABSTRACT

The invention relates to a process of use for deoxidizing silicon particles comprising at least the steps consisting in: (i) having surface-oxidized silicon particles that have a mean size of less than or equal to 10 μm, (ii) formulating said particles into the form of aggregates having a mean size ranging from 20 to 300 μm, (iii) bringing said aggregates from step (ii) into contact with a thermal plasma conveying hydrogen radicals under conditions suitable for the deoxidation thereof and for the non-evaporation thereof, and (iv) recovering a material deoxidized according to step (iii) in a liquid silicon bath.

The present invention relates to a novel process for deoxidizing silicon particles.

The material most commonly used for the production of photovoltaic cells is silicon in its bulk form, which represents 80% of the current market. These cells consist of a base approximately 200 μm thick, called a wafer, obtained by sawing a bulk silicon ingot.

Silicon ingots are currently cut up using two techniques. A first method uses wires which, by entrainment, convey an abrasive mixture (called slurry) based on polyethylene glycol (PEG) and on silicon carbide particles so as to cut and grind the silicon block. The second, which has emerged more recently, uses wires to which diamond carbon particles are attached. It makes it possible to cut up the silicon blocks at great speed, allows better control of the thickness of the wafers and generates fewer surface defects.

This cutting step is generally accompanied by a loss of material in the form of powder (called kerf loss) of approximately 30% to 40%, which then represents a not insignificant share of the cost of the solar cell.

With the objective of reducing these costs, it is important to recycle the silicon powders generated during the sawing of the bulk ingot.

Whatever the cutting technique retained, the recycling of the silicon powders resulting from the sawing requires, after separation thereof from the cooling fluid (called coolant—water-based product) and from the silicon carbide particles (only for the first cutting process mentioned above), a surface deoxidation step aimed at removing a layer of silica (SiO₂) that has formed.

Indeed, only deoxidized powders, i.e. powders having as low an oxygen content as possible, ideally less than or equal to 10% by weight relative to the total weight of the powders, may be reintroduced into the ingot production line as a mixture with standard material, of solar grade or else of electronic grade.

Techniques have already been proposed for the purpose of reducing the oxygen content in the recycled silicon powder.

The method most commonly used for obtaining deoxidation of sawing powders consists in carrying out a chemical treatment of the particle surface by means of acid attacks. These treatments use hydrofluoric acid (HF) as deoxidation agent [1].

This method proves to be effective and makes it possible to achieve oxygen content levels of approximately 1%. However, the deoxidation kinetics depend essentially on the HF content in the acid solution. Furthermore, this method appears to be unsuitable for moving to an industrial scale since large amounts of hydrofluoric acid, which is a highly toxic acid that it would be necessary to recycle, are used to achieve the yield mentioned above.

The surface silica may also be reduced by means of the silicon itself. At low pressure and at a temperature of 1000 to 1300° C. or at atmospheric pressure and at temperatures of about 1600° C., the reduction of silica by silicon occurs so as to give, as reaction product, gaseous silicon monoxide SiO according to the following reaction: SiO₂+Si→2SiO. This reaction is nevertheless accompanied by a considerable loss of material through volatilization of the silicon in the form of SiO and generates very low material yields.

Likewise, in a temperature range of between 200 and 850° C., it is also possible to achieve a reduction of the silica by means of aluminum (process known as aluminothermy) according to the overall reaction: 3SiO₂+4Al→2Al₂O₃+3Si. However, the silicon resulting from this reaction forms an alloy with the excess reducing agent [2], thereby greatly complicating the recovery of the latter. A similar reaction scheme also occurs in the presence of magnesium or calcium as reducing agents.

Finally, the use of plasma discharges using hydrogen as reducing agent is also known from the prior art [3,4]. The reduction of the oxidized metals generally follows the following reaction scheme:

MeₓO_{y}+2nH→MeₓO_{y-n}+nH₂O

The source of excited hydrogen may be obtained through a plasma discharge. The hydrogen is introduced as a mixture with a vector gas, generally argon, and dissociates under the effect of an electric field. For example, using a microwave discharge, it has been possible to reduce titanium oxide in its TiO₂ form to the form TiO by introducing the hydrogen atom into the matrix of the oxide.

Moreover, thermal plasma processes are known for their application to purification problems, in particular in terms of boron and in terms of metal impurities, on metallurgical grade silicon powders which have a particle size of between 60 and 120 μm [5].

However, the use of this type of plasma discharge proves to be impossible for the particle size range of silicon ingot sawing particles. Indeed, because of the high enthalpy of the plasma flow, the treatment results in total evaporation of the particles.

Consequently, the application of the technologies currently available to the deoxidation of silicon particles resulting from the sawing of ingots is not satisfactory, or even possible to envision from the viewpoint for example of the specificities of these particles, in particular in terms of size, but also in terms of yield or toxicity of the products used.

The present invention aims precisely to provide a process which meets the above-mentioned requirements.

Thus, the present invention relates to a process useful for deoxidizing silicon particles, comprising at least the steps consisting in:

(i) having surface-oxidized silicon particles that have a mean size of less than or equal to 10 μm,

(ii) formulating said particles into the form of aggregates having a mean size ranging from 20 to 300 μm,

(iii) bringing said aggregates of step (ii) into contact with a thermal plasma conveying hydrogen radicals under conditions suitable for their deoxidation and for their non-evaporation, and

(iv) recovering a deoxidized material according to step (iii) in a liquid silicon bath.

For the purposes of the invention, the term “particle” is intended to mean a unitary and individualized solid object. According to the invention, the particles have a mean size of less than or equal to 10 μm. The aggregate differs from a particle in the sense that it consists of several of these particles agglomerated together. The aggregates of the present invention have a mean size ranging from 20 to 300 μm.

For the reasons detailed hereinafter, the process of the invention proves to be advantageous in several respects.

Against all expectations, bringing these particles in the form of aggregates in accordance with the invention into contact with the reducing plasma makes it possible to obtain optimal deoxidation.

This process advantageously lends itself to immediate industrial recycling of the deoxidized particles for example for producing ingots through the recovery of the particles directly in a liquid silicon bath.

What is more, it is possible to continue, in the same facility, the treatment at the surface of the molten bath in order to reduce the concentration of oxygen not previously removed.

Other characteristics, advantages and modes of application of the process according to the invention will emerge more clearly on reading the description which follows, given by way of nonlimiting illustration, and in particular with reference to the appended drawings, in which:

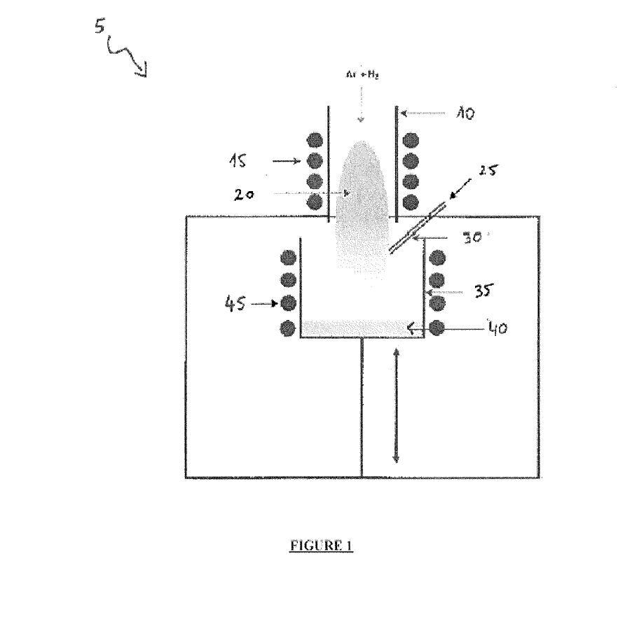

FIG. 1 represents, diagrammatically and partially, a facility suitable for the implementation of an embodiment of the process according to the invention;

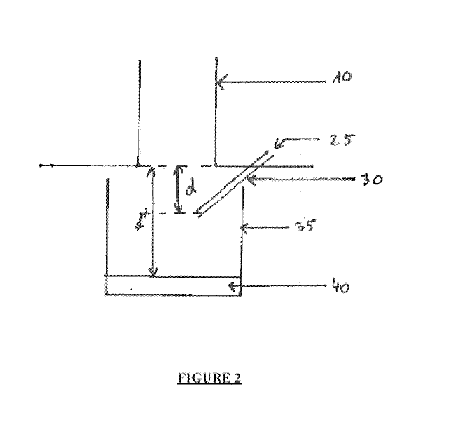

FIG. 2 represents a detail of the zone nearby the plasma torch output in the facility represented in FIG. 1.

It should be noted that, for reasons of clarity, the various elements in FIGS. 1 and 2 are represented on a free scale, the actual dimensions of the various parts not being observed.

In the remainder of the text, the expressions “between . . . and . . . ”, “ranging from . . . to . . . ” and “varying from . . . to . . . ” are equivalent and are intended to signify that the limits are included, unless otherwise mentioned.

Unless otherwise indicated, the expression “containing/comprising a” should be understood as “containing/comprising at least one”.

Silicon Particles

As previously specified, the silicon particles under consideration in the treatment according to the invention are generally derived from the cutting up of silicon ingots.

They are therefore surface-oxidized and have a mean size of less than or equal to 10 μm, or even less than 2 μm.

More particularly, the mean size of these particles may vary from 100 nm to 10 μm, preferably from 200 nm to 2 μm.

It should be noted that the mean size of the particles or aggregates under consideration according to the invention may be determined by image analysis using scanning electron microscopy (SEM) or optical microscopy. These technologies make it possible to determine the surface area of the objects observed and the mean size of the particles of aggregates then corresponds to the square root of such a surface area.

The choice between one or other of these techniques is made by those skilled in the art according to the order of magnitude of the entities under consideration. Thus, objects having a size less than 2 μm are preferentially measured by SEM, whereas objects having a size greater than 2 μm lend themselves both to the SEM technique and to optical microscopy.

Laser particle sizing may also be used in the present invention as a measurement supplementary to image analysis.

The surface-oxidized silicon particles generally have an oxygen content of greater than or equal to 20% by weight relative to the total weight thereof and advantageously of between 20% and 30%.

This oxygen content may, for example, be measured using the IGA (Interstitial Gas Analysis) technique known to those skilled in the art.

According to another of their specificities, these particles have, at the surface, a layer of silicon oxide having a thickness ranging from 5 nm to 50 nm.

Aggregates

As emerges from the aforementioned, the invention requires the deoxidation step to be carried out on silicon particles organized in the form of aggregates having a mean size ranging from 20 to 300 μm.

More particularly, the mean size of these aggregates may range from 50 μm to 200 μm.

Although not limited to one particular technique, this aggregation is advantageously carried out according to the invention by spray-drying of said silicon particles.

It should be noted that the spray drying uses an oxidizing liquid which induces additional oxidation of the silicon aggregates. Consequently, the originality of the process according to the invention is that it reinforces the degree of oxidation of the material to be treated prior to the deoxidation thereof. Against all expectations, the effectiveness of this subsequent deoxidation is optimized.

The spray-drying technique is in particular described in the document “Droplet and Particle Size Relationship and Shell Thickness of Inhalable Lactose Particles during Spray Drying” by Jessica Elversson et al., Journal of Pharmaceutical Sciences, Vol. 92, No. 4, April 2003.

Plasma

The process of the invention is limited to the use of a thermal plasma.

Advantageously, it is a thermal plasma at atmospheric pressure of arc or inductive type.

In a plasma arc torch, the plasma is produced by bringing a plasma-generating gas into contact with an electric arc, the latter being initiated between two electrodes.

In an inductive plasma torch, i.e. without electrode, the plasma is generated by high-frequency excitation of plasma-generating gas.

Preferably, the plasma of step (iii) is generated from a plasma torch, in particular by means of an inductive plasma torch, for example by means of an inductively coupled radiofrequency (RF) generator.

The use of an inductive plasma torch may prove to be advantageous compared with an arc torch insofar as it makes it possible to dispense with pollution of the deoxidized material by erosion of the high-voltage electrode.

Furthermore, inductive plasmas have the advantage of having much slower flow rates, thereby allowing quite long aggregate residence times, thus promoting the chemical interaction but also the thermal interaction.

The plasma torch used in the process according to the invention may, for example, have a power ranging from 1 to 120 kW, preferentially from 10 to 60 kW, and a frequency ranging from 1 to 20 MHz, preferentially from 2 to 5 MHz.

With regard to the gas flow rate of this torch, it may be between 40 and 250 L·min⁻¹, in particular between 60 and 150 L·min⁻¹.

Generally, the plasma torch operates at atmospheric pressure.

Those skilled in the art are capable of adjusting these parameters according in particular to the size of the aggregates and to the silicon oxide layer thickness thereof.

The term “plasma-generating gas(es)” is intended to denote the gaseous medium in which the plasma is created.

The plasma-generating gas under consideration according to the invention comprises hydrogen combined with a secondary inert gas, termed vector, and generally chosen from argon, helium and neon, and mixtures thereof. The proportion of hydrogen in the plasma-generating gas, also called plasma-generating gas mixture, varies more particularly from 0.5% to 50% by volume, in particular from 1% to 25% by volume. It is advantageously a mixture of hydrogen and argon.

When the plasma is formed, the hydrogen dissociates so as to form H* radicals according to the following reaction:

H₂+e⁻*→2H*+e⁻

The hydrogen radicals thus formed are conveyed by the associated vector gas, the latter preferably being an inert gas, advantageously argon.

The aggregates under consideration according to the invention are brought into contact with the plasma under conditions suitable for the deoxidation thereof and for the non-evaporation thereof.

The deoxidation is carried out according to the following chemical reaction:

SiO₂(s)+2H*→SiO(g)+H₂O(g)

During this reaction, the hydrogenated radicals formed in the plasma reduce the silica to gaseous silicon monoxide (SiO), thus enabling the aggregates to considerably reduce the thickness of their silicon oxide layer.

This reaction for surface deoxidation of the aggregates by chemical reaction with the hydrogenated radicals is accompanied by melting to the core due to the heat treatment.

The conditions of this treatment are adjusted by those skilled in the art so as to allow this melting to the core while limiting the evaporation of the silicon.

Thus, in order to prevent the manifestation of a phenomenon of total vaporization of the aggregates, they are advantageously introduced into the plasma in a post-discharge zone.

For the purposes of the invention, the “post-discharge zone” denotes the zone extending between the plasma torch output and the surface of the liquid silicon bath.

The term “plasma torch output” is intended to mean the lower base of the device or applicator for the plasma, in other words the lower base of the tube, which is generally cylindrical, in which the plasma is processed.

The introduction of the aggregates into this zone makes it possible to effectively limit the loss of material by heat evaporation because of lower temperatures (of about 3000 to 5000 K) compared with the zone included in the tube of the plasma torch. This results in a better material yield.

In particular, the aggregates may be introduced at a distance (d) ranging from 0.5 to 10 cm from the plasma torch output, and more specifically from 1 to 3 cm.

The residence time of the aggregates in the plasma of step (iii) may vary from 1 to 50 ms, preferably from 5 to 20 ms.

The adjustment of this distance (d) and of the residence time are clearly within the competence of those skilled in the art.

Thus, for aggregates having a high oxygen content, typically of about 30% by weight relative to the total weight thereof, it is advantageous to favor an injection close to the plasma torch outlet, i.e. in a zone where the temperature is higher so as to promote the activation of the deoxidation reaction and to prolong the residence of the aggregates injected into the plasma.

With regard to the injection of the aggregates in the post-discharge zone, it is advantageously carried out via a carrier gas, preferably an inert gas, in particular argon.

Preferably, the carrier gas is introduced at a flow rate ranging from 1 to 20 L·min⁻¹, preferably from 2 to 10 L·min⁻¹.

The process according to the invention makes it possible to easily recover the deoxidized material of step (iii), this being with a good yield owing to the fact that this material is in the liquid phase.

More specifically, during step (iv), the deoxidized material from step (iii) is recovered in a liquid silicon bath.

This bath may, for example, be prepared from silicon melted beforehand, preferably by means of an inductive or resistive heating system.

The silicon contained in this bath may be chosen from standard silicon, solar grade silicon, electronic grade silicon, and mixtures thereof.

This recovery of the deoxidized material may be carried out continuously in the liquid silicon bath. The whole thing may be reintroduced into the ingot production line, which ingots may be used in particular for producing photovoltaic cells.

The surface of the liquid silicon bath is advantageously located at a distance (d′) ranging from 5 to 30 cm from the torch output, and more particularly from 5 to 10 cm.

The crucible containing the silicon bath may be placed on a translation device capable of moving the bath along the vertical axis such that the distance (d′) varies as little as possible throughout the process.

According to one particular embodiment, the process according to the invention also comprises a step (v) in which the liquid silicon bath containing the deoxidized material from step (iii) undergoes a treatment with the thermal plasma so as to complete the deoxidation.

This additional step thus makes it possible to further reduce the oxygen content of the material recovered in step (iv).

In order for it to be possible for the treatment to continue on the liquid silicon bath, the surface of the liquid silicon bath is advantageously at a distance (d″) ranging from 5 to 10 cm from the torch output, said liquid bath being at a temperature below 1600° C., preferably below 1550° C.

Advantageously, the material obtained in step iv) or, where appropriate, in step v) has an oxygen content of less than or equal to 10% by weight, preferably less than or equal to 5% by weight, relative to the total weight of said material. These concentrations are measured by the IGA technique either on the solidified ingot, or using samples taken in the liquid phase and then solidified. The weight of deoxidized material is, in parallel, assessed on the basis of the difference in weight of the liquid silicon bath before and after treatment.

In the remainder of the text, reference will be made to the appended FIGS. 1 and 2, which represent, diagrammatically and partially, a facility 5 suitable for the implementation of an embodiment of the process of the invention according to which the plasma torch is of inductive type and the aggregates are introduced in the post-discharge zone.

The facility comprises an inductive plasma torch 10, in the form of a tube, made of insulating material, for example made of quartz, intended for the formation of the plasma.

The high-frequency field for creating the plasma is produced by a winding coil around the tube consisting of induction coils 15, fed by a high-frequency generator of sufficient power.

A mixture of plasma-generating gas(es), for example argon and hydrogen, is injected into the upper part of the tube. During the transit of the gases in the tube, a plasma jet 20 forms by electromagnetic coupling.

The silicon aggregates 25 obtained in step (ii) are injected, for example, by means of a carrier gas, which is preferably inert, in particular argon, at the input of an injector 30 which may be made of graphite.

Advantageously, the diameter of the injector 25 at its output may be considerably reduced compared with the diameter of the input of the injector, so as to increase the speed of the aggregates when they leave the injector via a venturi effect and to thus force them to penetrate into the plasma.

The deoxidized material is then collected in a crucible 35, for example based on graphite, comprising a liquid silicon bath 40. The silicon forming the bath is premelted, and kept in the liquid state by means of a resistive or inductive heating system. According to one preferential embodiment, the heating is inductive comprising induction coils 45.

FIG. 2 represents diagrammatically the distance (d) which corresponds to the distance between the output of the plasma torch and the output of the injector by which the silicon aggregates are introduced.

FIG. 2 also represents the distance (d′) which corresponds to the distance between the output of the torch and the surface of the silicon bath.

Of course, the device may conventionally comprise means not represented in FIGS. 1 and 2, for controlling the feed flow rate of the torch, and also the feed flow rate of the injector 25, for example by means of valves.

The invention will now be described by means of the following example given, of course, by way of nonlimiting illustration of the invention.

### EXAMPLE

The crude powders recovered during the process of cutting up a silicon ingot with a diamond-comprising wire have a size of between 600 nm and 1 μm. They are placed in an aqueous suspension.

Aggregates are then formed by spray drying. To do this, the powders are introduced into the reservoir of a Niro spray dryer, the turbine of which operates at 7000 revolutions per minute. The aqueous suspension, called slip, is then injected at a flow rate of 10 L·h⁻¹. The aggregates obtained have an average size, measured by laser particle sizing, of between 60 and 80 μm.

The aggregates are then treated with a hydrogenated argon thermal plasma, which has a hydrogen content of 2% by volume.

The device retained is composed of a torch which makes it possible to confine the plasma discharge. Said discharge is initiated by means of a radiofrequency induction generator having a maximum power of 25 kW and operating at a frequency of about 4 MHz. In this example, the power applied is fixed at 18 kW for a total gas flow rate of 60 L·min⁻¹.

The aggregates are stored in a tank and transported into the plasma by means of an argon vector gas, the flow rate of which is fixed at 3 L·min⁻¹. The injection is carried out by means of a graphite injector, the diameter of which has been reduced by a factor of 2 at the injection zone in order to increase the speed of the particles leaving so as to force their injection into the plasma jet.

The injection is carried out in the post-discharge zone, in the case in point at a distance of 2 cm from the plasma torch output. The aggregate residence time is approximately 15 ms. The aggregates entrained in the plasma flow undergo surface deoxidization by chemical reaction with the hydrogenated radicals and melting to the core by means of the heat treatment.

The molten particles then feed the surface of a silicon bath melted beforehand by means of an inductive heating system having a frequency of 250 kHz and a power of 30 kW. The amount of premelted silicon is approximately 1 kg, the crucible dimensions being 40×40×40 cm. The surface of the bath is 10 cm below the torch output.

The material balance, calculated by calculating the ratio of the weight of silicon recovered relative to the weight of the powders entering, makes it possible to conclude that there is a material yield of about 60% to 70%. At the end of the test, a silicon ingot derived from the recycling powders is obtained so as to be introduced as a mixture with standard material into the bulk silicon production line.
[1] T. Y. Wang, Y. C. Lin, C. Y. Tai, C. C. Fei, M. Y. Tseng, C. W., LanProgress in photovoltaics: Research and Applications, 2009, 17:155-163.
[2] Ferhad Dadabhai, Franco Gaspari, Stefan Zukotynski,a) and Colby Bland J. Appl. Phys. 80 (11), 1996, 6505-6509.
[3] A. A. Bergh, The BELL Technical system Journal, 1965, 261-271.
[4] Alexander Fridman, Plasma Chemistry, Cambridge University Press, 2008, 978 pages.
[5] M. Benmansour, E. Francke, D. Morvan, Thin Solid Films, Vol. 403, 2002, 112-115.

1. A process useful for deoxidizing silicon particles, comprising at least the steps consisting in:
(i) having surface-oxidized silicon particles that have a mean size of less than or equal to 10 μm,
(ii) formulating said particles into the form of aggregates having a mean size ranging from 20 to 300 μm,
(iii) bringing said aggregates of step (ii) into contact with a thermal plasma conveying hydrogen radicals under conditions suitable for their deoxidation and for their non-evaporation, and
(iv) recovering a deoxidized material according to step (iii) in a liquid silicon bath.

2. The process as claimed in claim 1, wherein said surface-oxidized silicon particles of step (i) have an oxygen content of greater than or equal to 20% by weight relative to their total weight.

3. The process as claimed in claim 1, wherein the surface-oxidized silicon particles of step (i) have, on the surface, a silicon oxide layer having a thickness ranging from 5 nm to 50 nm.

4. The process as claimed in claim 1, wherein said surface-oxidized silicon particles of step (i) have a mean size varying from 100 nm to 10 μm.

5. The process as claimed in claim 1, wherein said aggregates of step (ii) have a mean size ranging from 50 μm to 200 μm.

6. The process as claimed in claim 1, wherein said aggregates of step (ii) are formed by spray-drying of said silicon particles.

7. The process as claimed in claim 1, wherein the gas within which the plasma of step (iii) is formed comprises an inert gas chosen from argon, helium and neon, and their mixtures, and also hydrogen in a proportion ranging from 0.5% to 50% by volume.

8. The process as claimed in claim 1, wherein the plasma of step (iii) is generated from a plasma torch.

9. The process as claimed in claim 1, wherein said aggregates are injected on contact with said plasma in the post-discharge zone, via a carrier gas.

10. The process as claimed in claim 1, wherein step (iv) of recovering the deoxidized material is carried out continuously in said liquid silicon bath.

11. The process as claimed in claim 1, comprising a step (v) in which the liquid silicon bath containing the deoxidized material of step (iii) undergoes a treatment with said thermal plasma so as to complete the deoxidation.

12. The process as claimed in claim 1, wherein the material obtained in step (iv) or, where appropriate, in step (v) has an oxygen content of less than or equal to 10% by weight, relative to the total weight of said material.
